(19) United States
(12) Patent Application Publication
(10) Pub. No.: US 2006/0016256 A1
(43) Pub. Date: Jan. 26, 2006

(54) Filling level sensor for a tank

(75) Inventors: Matthias Bauerle, Wassertrudingen (DE); Roland Huttinger, Treuchtlingen (DE); Markus Stephan, Gnotzheim (DE)

Correspondence Address: DORITY & MANNING, P.A., POST OFFICE BOX 1449, GREENVILLE, SC, 29602-1449, US

(73) Assignee: Alfmeier Prazision AG, Baugruppen und Systemlosungen

(21) Appl. No.: 11/167,569

(22) Filed: Jun. 27, 2005

(30) Foreign Application Priority Data
Jun. 28, 2004 (DE) 10 2004 031 074.2
Jan. 26, 2005 (DE) 10 2005 003 741.0

(51) Int. Cl. G01F 23/38; G01F 23/36

(52) U.S. Cl. 73/313; 73/314; 73/317; 73/DIG. 5

(57) ABSTRACT

A filling level sensor (6) for a tank (4), particularly a tank of a motor vehicle that can be filled with fuel (20), comprises a bridge that can be displaced along at least two electric sliding contacts by means of an actuator in dependence on the filling level (26). The actuator consists of an actuator that generates a magnetic field (38), and the bridge consists of a conglomerate (36) of electrically conductive particles that can be moved by the magnetic field (38).

List of References Symbols

2 Interior
4 Motor vehicle fuel tank
6 Filling level sensor
8 Base plate
10 Potentiometer
12 Lever arm
14 Float
16 Pivot pin
18 Arrow
20 Fuel
24 Wall
26 Filling level
28 Arrow
30 Free end
32 Permanent magnet
34 Front side
36 Particle contact
38 Field
40 Arrow
42 Resistor track
44 Contact track
46a, b Terminal
48 Housing cover
50 Cavity
51 Rear side
52 Bow
54 Free end
56 Permanent magnet
58 Inner side
60 Arrow
62 Guide member
64 Longitudinal center axis
66, 68 Flange
70 Rear side
72a, b Float
74 Center limb
76 Contact pin
78 Limit stop
80 Arrow

The invention pertains to a filling level sensor for a tank, particularly for the fuel tank of a motor vehicle.

Various systems are utilized for determining the filling level of a tank, particularly the fuel tank of a motor vehicle. Most of these systems are designed such that a float controls an electric potentiometer via a lever arm in dependence on the filling level in the fuel tank. This means that the slider of the potentiometer and consequently its electrical properties, e.g., the ohmic resistance between two potentiometer terminals, changes in dependence on the filling level. The change or adjustment of the potentiometer makes it possible to ascertain the filling level in the tank.

In comparison with older fuels, the fuels available on the market these days contain less sulfur or more aggressive additives, i.e., modem fuels are altogether more aggressive. This causes, for example, the resistor track or the contact track or the slider of the potentiometers to be attacked by the fuels, fuel vapors, etc. The electrical properties of the potentiometer change in an unpredictable fashion over the lifetime of a tank or a corresponding filling level sensor, respectively. This means that the filling level of the tank is no longer correctly indicated.

Some modem systems are also subject to wear phenomena, e.g., due to electromechanical sliders being displaced along resistor tracks or contact tracks. Contaminants may also be deposited on the track. This means that the contact between the slider and the track deteriorates or is even interrupted. This can lead to false readings of the filling level, malfunctions or even the complete failure of the filling level sensor.

Various measures are available in order to remedy this problem and to permanently obtain a flawless reading of the filling level. For example, it has been proposed to realize the sensitive electric components, e.g., the resistor track in the sensor, such that they are insensitive to fuel or the formation of a coating on the resistor track of the sensor or potentiometer is prevented. In publications DE 100 28 893 A1, U.S. Pat. No. 6,404,331 B1, DE 100 49 373 A1 or U.S. Ser. No. 09/679,425, it is proposed to utilize more precious materials, e.g., for the resistor track of the potentiometer in question. However, this increases the cost of a filling level sensor of this type due to the higher material expense and the more complicated manufacture. In addition, the accumulation of contaminants on the tracks or wear phenomena cannot be prevented with these measures.

It has also been proposed in various publications to completely encapsulate the filling level sensor such that its sensitive components can no longer come in direct contact with the fuel or fuel vapors. For example, DE 102 29 280 A1 proposes a pivoted toric magnet that is coupled to a Hall sensor. DE 197 01 246 A1 proposes a plurality of lamellae that can be moved magnetically. A filling level sensor with thermoelements is realized in DE 102 37 946 A1. The main disadvantages of these systems are their complexity, their complicated manufacture as well as the high costs and the susceptibility to errors resulting therefrom.

The invention is based on the objective of disclosing an improved filling level sensor.

This objective is attained by providing a filling level sensor for a tank, particularly for the fuel tank of a motor vehicle, with a bridge that can be displaced along at least two electric sliding contacts by an actuator in dependence on the filling level in the tank, wherein said filling level sensor is characterized in that the actuator consists of an actuator that generates a magnetic field, and in that the bridge consists of a conglomerate of electrically conductive particles that can be moved by the magnetic field.

In other words, the conglomerate forms a particle contact in the form of a bridge that locally bridges the electric sliding contacts at a certain location similar to a conventional slider. The position of the bridging point, namely the instantaneous position of the particle contact, depends on the filling level in the tank because the conglomerate can be displaced on or along the sliding contacts by the actuator such that the bridging respectively takes place at different locations depending on the filling level. The sliding contacts are realized in such a way that they have different electrical properties depending on the position at which they are bridged by the conglomerate. For example, different sliding contacts can be electrically interconnected in dependence on the position of the bridge such that different current paths are closed in dependence on the filling level in the tank or different resistors are realized due to the composition of the track.

The evaluation, e.g., of the current paths with the aid of a suitable electric circuit therefore provides information on the filling level in the tank. The sliding contacts deliver an electric signal that depends on the filling level in the tank.

The conglomerate is adjusted on the sliding contacts by the magnetic field generated by the actuator, i.e., the filling level sensor operates in a contactless fashion. A mechanical or movable connection between the actuator and the sliding contacts or the particle contact is not required.

Since the particle contact consists of a conglomerate in the form of a drop of electrically conductive particles that can be moved by the magnetic field of the actuator, the friction within the drop as well as the friction between the drop and the electric sliding contacts is reduced to a minimum. The adjusting forces required for moving the particles are also very low. Since the contact bridge consists of a coherent conglomerate of particles, this conglomerate only produces a local connection between the sliding contacts, namely also when concussions occur. This is the reason why the electrical properties of the bridged sliding contacts change in dependence on the filling level in a sufficiently accurate fashion.

The particles may consist of magnetic or magnetizable powder particles or hollow balls that are coated with a protective layer. Magnetic or magnetizable particles can be easily and inexpensively manufactured in the form of a powder or hollow balls. Due to their magnetic properties, they can be moved by the magnetic field of the actuator such that the bridge, i.e., the particle contact or powder drop, moves along the sliding contacts under the influence of the magnetic field. The additional protective layer, e.g., a protective lacquer or a precious metal coating, protects the particles or hollow balls from fuel and fuel vapors. Consequently, the magnetic properties of the conglomerate, i.e., the particle contact, are not altered and the filling level sensor does not deteriorate over time due to the effects of the fuel.

The protective layer may also reduce the internal friction within the conglomerate, i.e., the friction between the particles, as well as the friction between the conglomerate and the sliding contacts, and thusly contribute to a reduction in the force required for moving the bridge. For example, magnetic particles may be provided with a layer of gold or another precious metal that protects the particles, in particular, from oxidation or a chemical reaction with sulfur or other aggressive constituents of the fuel. It would also be conceivable to utilize a mixed-particle conglomerate, in which some of the particles are conductive and some of the particles are magnetic. The particles may also be bound in a carrier fluid, e.g., a viscous oil, and form the conglomerate together with this fluid.

The particles may consist of nanoparticles. Nanoparticles are able to form a conglomerate with particularly favorable properties. Due to the minute size of the nanoparticles, the conglomerate can be realized, for example, similar to an oil drop that adequately adheres to the sliding contacts and can be displaced thereon without disintegrating or excessively wetting the surface.

A series of discrete sliding contacts that are or are not bridged in pairs by the bridge, e.g., in dependence on the position thereof, need to be contacted at various locations in order to obtain an electric output signal that also takes into account slight fluctuations of the filling level. Consequently, the sliding contacts may consist of a resistor track and a contact track that form a potentiometer together with the conglomerate that connects and can be moved along the resistor track and the contact track. A potentiometer usually has only two or three terminals. The corresponding resistor track is frequently realized such that it has a continuous resistance characteristic, i.e., even the slightest movements of the bridge result in a continuous change in the electrical properties of the potentiometer. This means that the accuracy of reading of a corresponding filling level sensor or the accuracy of indication of the sliding contacts and consequently of the filling level sensor is improved.

Many indicating instruments, e.g., fuel gauges, are designed for direct connection to a potentiometer. Consequently, indicating instruments of this type can still be used in connection with the filling level sensor according to the invention.

The resistor track design also makes it possible to adapt the resistor track to the tank geometry. In this case, it is advantageous if the resistor track has a non-linear resistance characteristic in the moving direction of the bridge, i.e., the particle contact or the particle bridge. For example, this makes it possible to eliminate a costly evaluation circuit that serves for converting the output values of a linear potentiometer into the filling level in the tank and that is usually arranged between the filling level sensor and a gauge.

The contactless coupling between the actuator and the conglomerate by means of the magnetic field makes it possible to suitably shield the sliding contacts relative to aggressive fuel or fuel vapors by means of an encapsulation. This means that the sliding contacts and the conglomerate can be arranged in a housing that is tightly sealed relative to harmful substances and that is pervious to the magnetic field. The sliding contacts and the conglomerate consequently are hermetically sealed relative to harmful substances and protected from oxidation or dirt layers, namely without being subjected to any wear or chemical influences. The actuator is situated outside the housing and acts upon the conglomerate in a contactless fashion through the housing wall. Movable parts do not have to be provided with a lead-through from the actuator to the bridge such that on the other hand the quality of the encapsulation can be significantly improved and the costs are drastically lowered. An abundance of suitable materials that are resistant to harmful substances as well as pervious to a magnetic field are commercially available.

The housing may comprise two housing halves of plastic that accommodate the conglomerate between one another, wherein the resistor track and the contact track are respectively impressed in one housing part or applied thereon in the form of a coating or fixed therein in the form of an insert. Additional components can be eliminated by impressing or applying a coating of the resistor track or the contact track on a housing half or a housing part of plastic, namely because it is no longer necessary to manufacture a separate resistor track on a substrate and to connect the resistor track to the housing part. The plastic should have, for example, a high mechanical strength and a low swelling tendency in fuel, e.g., polyphthalamide. The sliding contacts, in contrast, may consist of a material that can be suitably impressed on the housing parts. The housing may be reinforced with fiberglass and is particularly well suited, for example, for applying the sliding contacts by means of screen printing.

In addition, the assembly of the filling level sensor is significantly simplified because both housing parts can be manufactured separately and the conglomerate in the form of contact material, e.g., powder or hollow balls, can be easily and quickly introduced therein during the final assembly of the housing. The shape of the housing may be realized in such a way that a hollow guide channel for the particle contact is formed. This hollow guide channel provides the particle contact with a certain clearance for its movement along the resistor track and the contact track, but restricts other degrees of freedom transverse to the desired moving direction. This means that the particle contact cannot separate from the contact track or the resistor track and interrupt the electric connection between the tracks.

The actuator may consist of a permanent magnet. Nowadays, permanent magnets are inexpensively available in large quantities and generate sufficiently strong magnetic fields, wherein these permanent magnets can also be easily handled and mounted, for example, on a lever arm in the form of an actuator. This ensures that the corresponding magnetic field for adjusting the bridge is reliably generated over the lifetime of the filling level sensor. It is no longer necessary to provide an additional means for generating the magnetic field, e.g., an electric current flowing through a coil.

The actuator may contain two permanent magnets that enclose the bridge and the sliding contacts between one another. Two such permanent magnets, the polarities of which are suitably aligned or adapted relative to one another, generate a particularly strong magnetic field that guides and holds the particle contact in position between the two permanent magnets. If the sliding contacts are also arranged between the particle contact and a permanent magnet, the particle contact is subjected to a particularly strong attraction by both sliding contacts that respectively face one permanent magnet. This ensures that a reliable electric contact is produced between the bridge and the sliding contacts. Therefore, the uninterrupted contacting of the sliding contacts is also ensured when the filling level sensor is subjected to concussions. In addition, the conglomerate is prevented from dividing and forming two separate particle contacts.

The actuator may be motively coupled to a float, the position of which is dependent on the filling level in the tank. A float is a very simple and dependable element that follows the filling level of the liquid situated in the tank in a particularly reliable fashion. The motive coupling between the float and the actuator therefore ensures that the actuator also follows the filling level in the tank very well. Consequently, the filling level sensor delivers a very accurate signal at its sliding contacts in dependence on the filling level in the tank.

The housing may be realized on the form of an axial guide for the float, and the actuator may be rigidly fixed on the float. The float can be very easily guided along the housing in this fashion. A mechanical reversing mechanism, a special axial bearing, etc., is not required between the actuator and the float. This additionally reduces the number of mechanical parts such that the filling level sensor can be realized in a particularly simple and inexpensive fashion.

The risk of movable parts getting caught on the tank or tank installations is lowered. The overall installation volume of the filling level sensor is reduced and an improved flexibility is achieved with respect to the positioning of the filling level sensor within the tank.

The invention is described in greater detail below with reference to the embodiments illustrated in the figures. The schematic figures respectively show:

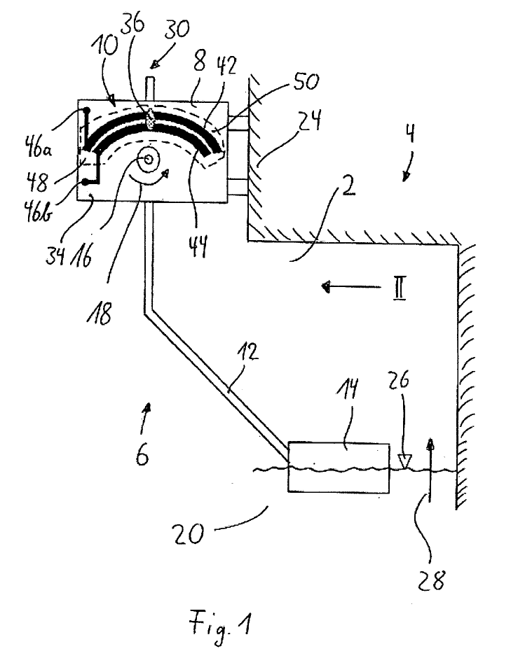

FIG. 1, a front view of a filling level sensor with potentiometer and particle contact, wherein the housing cover is open in this figure;

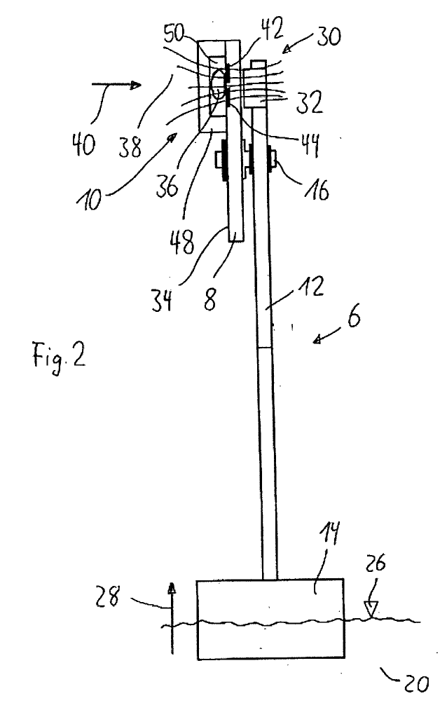

FIG. 2, the filling level sensor according to FIG. 1 with attached housing cover viewed in the direction of the arrow II;

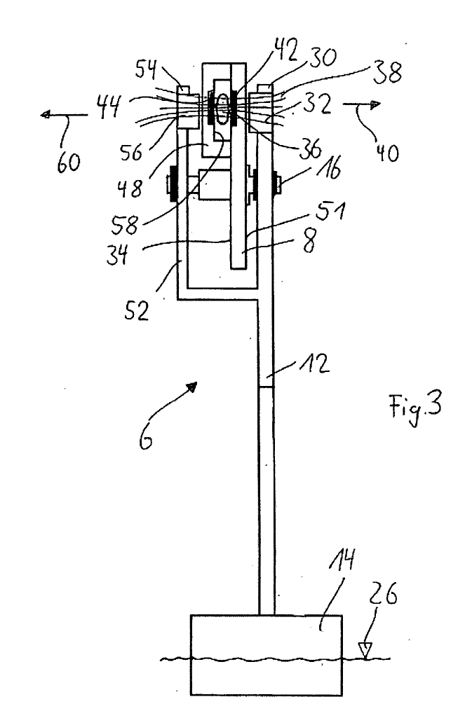

FIG. 3, a representation analogous to FIG. 2 of an alternative double-magnet variation of the filling level sensor according to FIGS. 1 and 2;

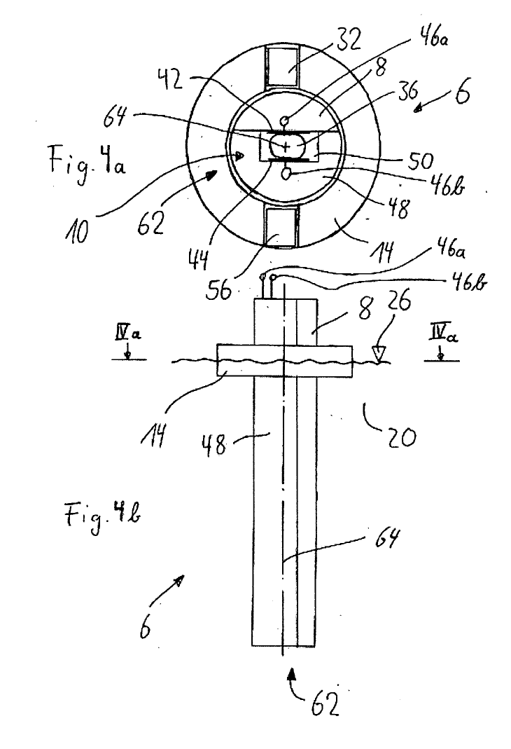

FIG. 4, an alternative filling level sensor without reversing mechanism, namely in the form of a) a top view sectioned along the line IVa-IVa and b) a side view;

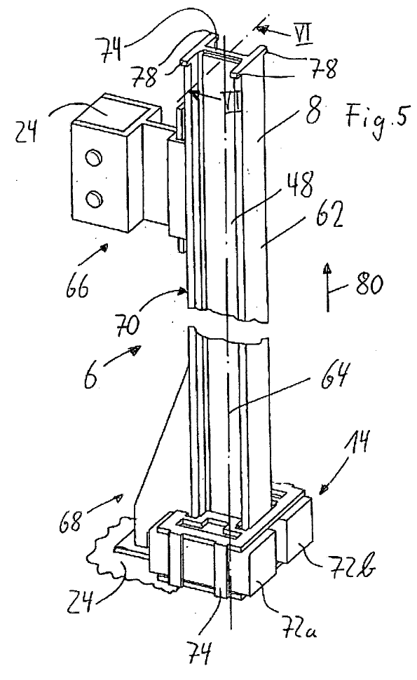

FIG. 5, a perspective representation of an alternative variation of the filling level sensor according to FIG. 4, and

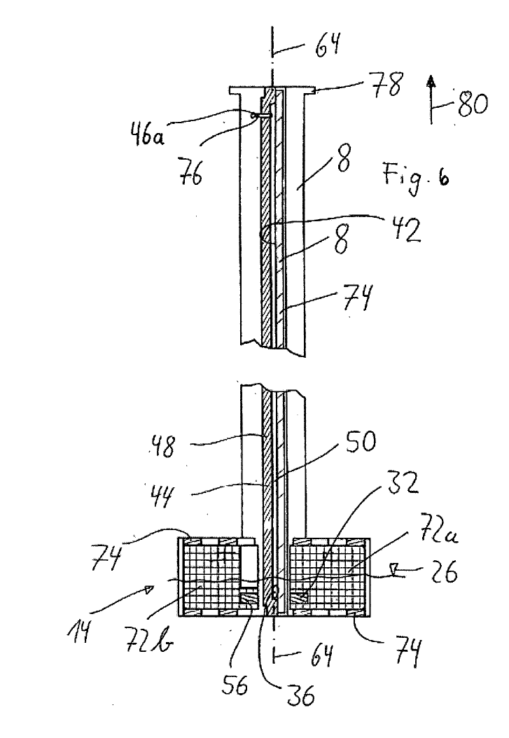

FIG. 6, a section through the filling level sensor according to FIG. 5 along the line VI-VI.

FIG. 1 shows a filling level sensor 6 that is situated in the interior 2 of the fuel tank 4 of a motor vehicle. The filling level sensor 6 comprises a base plate 8 with a potentiometer 10 arranged thereon, as well as a float 14 that is arranged on a lever arm 12. The float 14 floats on the surface of the fuel 20 situated in the interior 2 of the fuel tank. The lever arm 12 is supported on the base plate 8 with the aid of a pivot pin 16, namely such that it can be pivoted in or opposite to the direction of the arrow 18. The filling level sensor 6 is mounted with its base plate 8 on the wall 24 of the motor vehicle tank 4 or on a not-shown holder within the tank, e.g., a flow indicator unit or a module holder or the like.

When the filling level 26 of the fuel 20 in the fuel tank 4 rises in the direction of the arrow 28, the float 14 follows the filling level 26 approximately in the direction of the arrow 28, namely along a circular path around the pivot pin 16. This causes the lever arm 12 to also move around the axis 16 in the direction of the arrow 18.

FIG. 2 shows a permanent magnet 32 that is fixed on the free end 30 of the lever arm 12 that lies opposite the float 14, wherein this permanent magnet is covered by the base plate 8 in FIG. 1. A particle contact 36 is situated on the front side 34 of the base plate 8 that lies opposite the permanent magnet 32, wherein said particle contact is attracted toward the base plate 8 in the direction of the arrow 40 by the magnetic field 38 generated by the permanent magnet 32.

The particle contact 36 subjected to the attraction of the magnetic field 38 is realized in an electrically conductive fashion and electrically bridges a contact track 44 and a resistor track 42.

The particle contact 36 consists of a conglomerate of small powder particles or nanoparticles or hollow balls that are realized in an electrically conductive fashion and can be attracted by the magnetic field 38. In this case, the magnetic particles are coated with a thin gold layer. The particles attract one another such that a coherent drop is formed.

The potentiometer 10 is composed of the resistor track 42, the contact track 44 and the particle contact 36 that forms the bridge connecting said tracks. The contact track 44 and the resistor track 42 are arranged on the base plate 8 in such a way that the permanent magnet 32 always lies diametrically opposite the contact track 44 and the resistor track 42 referred to the base plate 8 when the permanent magnet 32 is pivoted together with the lever arm 12. Consequently, the particle contact 36 moved by the permanent magnet 32 constantly bridges the contact track 44 and the resistor track 42 at a certain location that is dependent on the filling level 26 due to the motive coupling formed by the float 14, the lever arm 12, the magnet 32 and the particle contact 36. An ohmic resistance that is dependent on the filling level 26 consequently can be tapped at the electric terminals 46a and 46b of the contact track 44 and the resistor track 42. Although not illustrated in the figures, the terminals 46a, b are respectively connected to an evaluation circuit and an electric fuel gauge.

The housing cover 48 illustrated with broken lines in FIG. 1 is connected to the base plate 8 in a hermetically sealed fashion, e.g., clipped, bonded, cast or welded. The base plate 8 and the housing cover 48 consequently enclose a cavity 50 that is hermetically sealed relative to the interior 2 of the vehicle fuel tank 4. The contact track 44, the resistor track 42 and the particle contact 36 therefore cannot come in contact with and be attacked by the fuel 20 or other harmful substances situated in the fuel tank, e.g., fuel vapors or the like.

The particle contact 36 is moved in a contactless fashion, namely by the magnetic field 38 of the permanent magnet 32. The particle contact 36 moves in a nearly frictionless and wear-free fashion on the base plate 8, as well as on the contact track 44 and the resistor track 42. The cavity 50 guides the particle contact similar to a channel.

The respective lead-through of the connecting lines 46a, b through the housing cover 48 and the base plate 8 needs to be sealed accordingly.

The cavity 50 also forms a guide channel for the particle contact 36. Consequently, the particle contact cannot separate from the contact track 44 and the resistor track 42 or disintegrate into several individual drops, namely even when the filling level sensor 6 is subjected to strong concussions.

FIG. 3 shows a modified embodiment of the arrangement according to FIGS. 1 and 2. In the region of the base plate 8, the lever arm 12 is extended in a U-shaped fashion by attaching an additional bow 52. This means that the lever arm 12 not only encompasses the base plate 8 on the rear side 51 as shown in FIGS. 1 and 2, but also on its front side 34. The bow 52 is supported on the pivot pin 16 that is realized longer than in FIGS. 1 and 2 analogous to the lever arm 12. A second permanent magnet 56 is arranged on the free end 54 of the bow 52.

The resistor track 42 on the base plate 8 is radially shifted toward the pivot pin 16 in comparison with the FIGS. 1 and 2. The contact track 44 is now situated on the inner side 58 of the housing cover 48, namely diametrically opposite the resistor track 42. This means that the particle contact 36 is situated between the resistor track 42 and the contact track 44.

With respect to their magnetic dipole moments, both permanent magnets 32 and 56 are polarized such that they respectively attract the particle contact 36 toward the resistor track 42 and the contact track 44 in the direction of the arrows 40 and 60 and press the particle contact against said tracks. This results in a very good electric contact between the particle contact 36 and the resistor track 42 and the contact track 44. In contrast to FIGS. 1 and 2, the magnetic field 38 generated by two permanent magnets 32 and 56 is stronger and more homogenous in the region of the particle contact 36.

FIG. 4 shows an alternative filling level sensor 6 that does not require a lever arm 12. FIG. 4b shows a side view of the filling level sensor, and FIG. 4a shows a section along the line IVa-IVa. The base plate 8 and the housing cover 48 form a cylindrical guide member 62 with a longitudinal center axis 64. The float 14 following the filling level 26 of the fuel 20 has the shape of a hollow cylinder that encompasses the guide member 62 and can be axially displaced along its longitudinal center axis 64. A not-shown axial guide prevents the float 14 from being turned relative to the guide member 62 in the circumferential direction. Both permanent magnets 32 and 56 are respectively fixed or installed, cast, foam-encased or the like directly in the float 14. These two permanent magnets are displaced relative to the guide member 62 in the axial direction as they follow the filling level 26 together with the float.

A straight, axially extending cavity 50 of cuboid shape is formed in the interior of the guide member 62 on the boundary surface between the base plate 8 and the housing cover 48. Corresponding to FIG. 3, the resistor track 42 is applied on the housing cover 48 and the contact track 44 is applied on the base plate 8, e.g., by means of a screen printing method. In this case, both tracks extend straight in the axial direction of the guide member 62 and lead to the terminals 46a, b. The particle contact 36 is arranged in the cavity between the tracks and forms the potentiometer 10 together with said tracks. The magnets 32, 56 fix the particle contact 36 between themselves such that it follows the magnets during the axial movement of the float 14. This causes the particle contact to change its axial position between the contact track 44 and the resistor track 42 such that the electric resistance tapped at the terminals 46a, b is changed in dependence on the filling level 26.

Since the cavity 50 is hermetically sealed relative to the fuel 20, the electric potentiometer 10 is also protected from fuel 20, fuel vapors and other harmful substances although the guide member 62 is partially immersed in the fuel 22.

FIGS. 5 and 6 show an alternative embodiment of a filling level sensor 6 that operates in accordance with the principle shown in FIG. 4. The guide member 62 has an H-shaped cross section in this case and is encompassed in a U-shaped fashion by a float 14 that is adapted to this cross section. Two flanges 66 and 68 are arranged on the guide member 62, namely on the open side of the U, i.e., on the rear side 70 of the guide member 62. These flanges serve for solidly and securely mounting the fuel level sensor 6 on the wall 24 of the vehicle fuel tank 4 or on other not-shown internal brackets.

The float 14 essentially consists of two float members 72a, b that are arranged diametrically opposite referred to the guide member 62, wherein a clamp 74 is used for holding together and for guiding the float members on the guide member 62 in the axial direction thereof, i.e., along the longitudinal center axis 64.

FIG. 6 shows that the guide member 62 is again essentially composed of the base plate 8 and the housing cover 48. The approximately cuboid or plate-shaped housing cover 48 is connected to the center limb 74 of the H-shaped base plate 8 that carries the contact track 44, e.g., by means of welding. Analogous to FIGS. 3 and 4, these two parts form the cavity 50 for accommodating the particle contact 36.

The housing cover 48 carries the resistor track 42, the terminal 46a of which leads outward via a hermetically sealed contact pin 76. Both permanent magnets 32 and 56 are embedded in the float members 72a, b diametrically opposite one another analogous to FIG. 4a. The particle contact 36 is situated in the cavity 50 between the permanent magnets 32 and 56 and is axially displaced along the longitudinal center axis 64 together with the magnets and the float 14 in dependence on the filling level 26.

Naturally, the float 14 in the embodiment shown in FIGS. 5 and 6 may also be realized in one piece. In this case, the clamp 74 is not required and can be eliminated.

Limit stops 78 are integrally formed onto the base plate and prevent the float 14 from disengaging from the guide member 62 in the direction of the arrow 80. The mobility of the float 14 in the other direction is limited by the wall 24 of the fuel tank 4.

1. A filling level sensor (6) for a tank (4), particularly a tank of a motor vehicle that can be filled with fuel (20), comprising a bridge that can be displaced along at least two electric sliding contacts by means of an actuator in dependence on the filling level (26), characterized by the fact that the actuator consists of an actuator that generates a magnetic field (38), and by the fact that the bridge consists of a conglomerate (36) of electrically conductive particles that can be moved by the magnetic field (38).

2. The filling level sensor (6) according to claim 1, wherein the particles consist of magnetic or magnetizable powder particles or hollow balls that are coated with a protective layer.

3. The filling level sensor (6) according to claim 1 or 2, wherein the particles consist of nanoparticles.

4. The filling level sensor (6) according to one of the preceding claims, wherein the sliding contacts consist of a resistor track (42) and a contact track (44), and wherein the sliding contacts form a potentiometer (10) together with the conglomerate (36) that connects and can be moved along the resistor track (42) and the contact track (44).

5. The filling level sensor (6) according to one of the preceding claims, wherein the sliding contacts and the conglomerate (36) are arranged in a housing (8, 48) that is hermetically sealed relative to harmful substances and pervious to the magnetic field (38), and wherein the actuator is arranged outside the housing.

6. The filling level sensor (6) according to claim 5, wherein the housing (8, 48) comprises two housing parts of plastic that accommodate the conglomerate (36) between themselves, and wherein the resistor track (42) and the contact track (44) are respectively impressed in one housing part or applied thereon in the form of a coating or fixed therein in the form of an insert.

7. The filling level sensor (6) according to one of the preceding claims, wherein the actuator consists of a permanent magnet (32).

8. The filling level sensor (6) according to claim 7, wherein the actuator comprises two permanent magnets (32, 56) that enclose the conglomerate (36) and the sliding contacts (42, 44) between one another.

9. The filling level sensor (6) according to one of the preceding claims, wherein the actuator is motively coupled to a float (14), the position of which depends on the filling level (26) in the tank (4).

10. The filling level sensor (6) according to claim 9, wherein the housing (8, 48) is realized in the form of an axial guide (62) for the float (14), and wherein the actuator (32, 56) is rigidly arranged on the float.
